(19) United States
(12) Patent Application Publication
(10) Pub. No.: US 2015/0129097 A1
(43) Pub. Date: May 14, 2015

(54) RECESSED REMOVABLE TREAD PORTIONS FOR RETREADED TIRES

(71) Applicants: E. Bruce Colby, Greenville, SC (US); Dimitri G. Tsihlas, Greer, SC (US); Cesar E. Zarak, Simpsonville, SC (US)

(72) Inventors: E. Bruce Colby, Greenville, SC (US); Dimitri G. Tsihlas, Greer, SC (US); Cesar E. Zarak, Simpsonville, SC (US)

(73) Assignees: MICHELIN RECHERCHE ET TECHNIQUE, S.A., Granges-Paccot (CH); COMPAGNIE GENERALE DES ETABLISSEMENTS MICHELIN, clermont-Ferrand (FR)

(21) Appl. No.: 14/354,629

(22) PCT Filed: Oct. 31, 2011
(86) PCT No.: PCT/US11/58687

§ 371 Date: Apr. 28, 2014

(51) Int. Cl. B60C 11/02; B60C 11/12; B29D 30/56; B60C 11/00

(52) U.S. Cl. CPC B60C 11/02; B60C 11/005; B60C 11/12; B29D 30/56; B29K 2105/24
USPC 152/209.6; 156/96

(57) ABSTRACT

Particular embodiments of the invention comprise multi-wear layer tire treads for retreaded tires and methods of forming retreaded tires. In particular embodiments, a multi-wear layer tire tread includes a thickness bounded depth wise by a ground-engaging top side and a bottom side, the thickness extending laterally between opposing side edges and longitudinally in a lengthwise direction of the tread. Such tire tread may further include a removable tread portion recessed from the top side to form a subsequent wear layer, the removable tread portion extending into the tread thickness from the bottom side and terminating a distance below the top side, the removable portion having a width arranged between opposing interior surfaces of the tread recessed below the top side.

### BACKGROUND OF THE INVENTION

1. Field of the Invention

This invention relates generally to treads for retreaded tires, and more particularly, to precured treads having multiple wear layers with grooves arranged along a bottom side of the tread.

2. Description of the Related Art

When retreading tires, it is generally known to replace the tread with a new precured tread. In doing so, a tread is generally formed having grooves arranged along an outer side of the tread. In particular instances, grooves may also be arranged along an inner or bottom side of the tread to provide one or more tread wear layers, where different tread features are exposed as the tread wears depthwise into a thickness of the tread.

Treads for retreading may include recesses arranged along a bottom side of the tread for forming recessed voids when the tread bottom side is attached to a tire carcass. For example, grooves may be arranged along the tread bottom side used to form recessed grooves in the retreaded tire. The inclusion of these voids along the bottom side, however, reduce the overall stiffness of the tire tread elements. Also, the presence of these voids can cause distortion when curing pressure is applied to the assembled retread.

Accordingly, there is a need to provide a tread and a retreaded tire that is capable of providing a void that only occurs when a portion of the tread becomes exposed as the tire wears.

### SUMMARY OF THE INVENTION

Particular embodiments of the invention include a multi-wear layer tire tread for retreaded tires, retreaded tires having multi-wear layer treads, and methods for forming retreaded tires having a tread comprising multiple wear layers. Particular embodiments of the multi-wear layer tire tread includes a thickness bounded depthwise by a ground-engaging top side and a bottom side, the thickness extending laterally between opposing side edges and longitudinally in a lengthwise direction of the tread. Further embodiments include a removable tread portion recessed from the top side to form a subsequent wear layer, the removable tread portion extending into the tread thickness from the bottom side and terminating a distance below the top side, the removable portion having a width arranged between opposing interior surfaces of the tread recessed below the top side.

Particular embodiments of the retreaded tire include a multi-wear layer tire tread. The tire tread includes a thickness bounded depthwise by a ground-engaging top side and a bottom side, the thickness extending laterally between opposing side edges and longitudinally in a lengthwise direction of the tread. Such tread further includes a removable tread portion recessed from the top side to form a subsequent wear layer, the removable tread portion extending into the tread thickness from the bottom side and terminating a distance below the top side, the removable portion having a width arranged between opposing interior surfaces of the tread recessed below the top side. Further embodiments of the reteaded tire includes a tire carcass upon which the tire tread is annularly arranged and bonded.

Particular embodiments of such methods include the step of providing a tire carcass. Further steps of such method may further include providing a tread comprising a thickness bounded depthwise by a ground-engaging top side and a bottom side, the thickness extending laterally between opposing side edges and longitudinally in a lengthwise direction of the tread. The tread being provided in such methods may further include a removable tread portion recessed from the top side to form a subsequent wear layer, the removable tread portion extending into the tread thickness from the bottom side and terminating a distance below the top side, the removable portion having a width arranged between opposing interior surfaces of the tread recessed below the top side. Such methods may further include the step of bonding the tread to the tire carcass.

The foregoing and other objects, features and advantages of the invention will be apparent from the following more detailed descriptions of particular embodiments of the invention, as illustrated in the accompanying drawings wherein like reference numbers represent like parts of the invention.

### DETAILED DESCRIPTION OF THE DRAWINGS

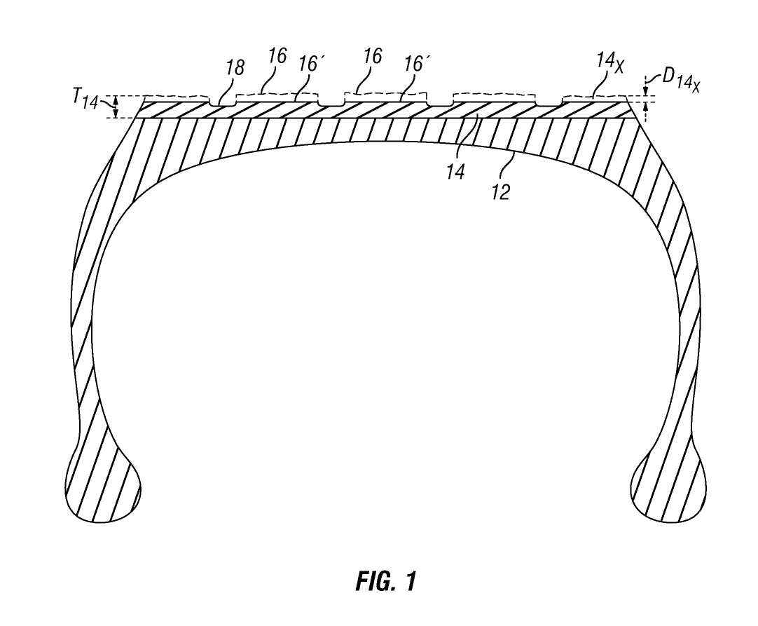

FIG. 1 is a partial front sectional view of a worn tire comprising a worn tread arranged atop a tire carcass, wherein a portion of the worn tread is removed according to a material removal method.

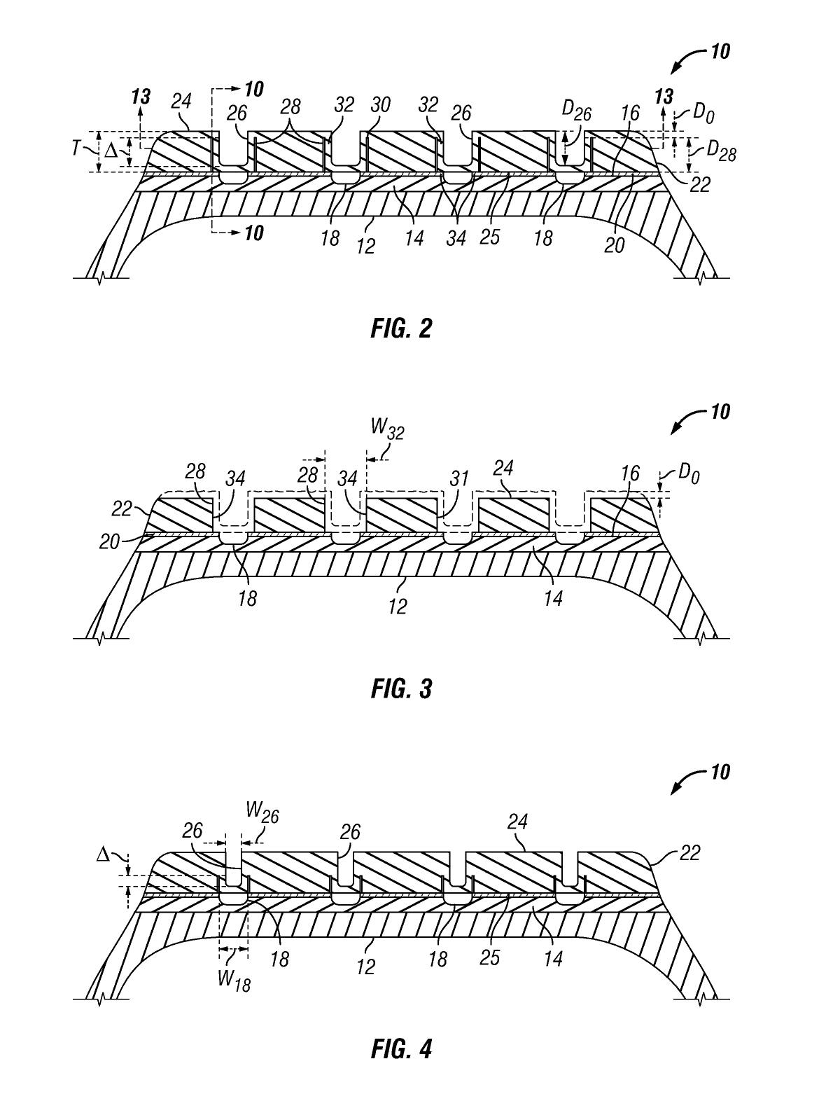

FIG. 2 is a partial front sectional view of a new tread layer applied to the tire of FIG. 1, the tire tread including a plurality of removable sections arranged along a bottom side of the tread according to a particular embodiment of the invention. In particular, each the removable section includes a top groove arranged along a top side of the tread. Bonding material is arranged between the tread and the tire carcass to facilitate attachment there between. In locations between the removable tread sections and the tire carcass, however, release material may be arranged to deter attachment of the removable tread portion to the tire carcass and therefore facilitate removal of the removable section when sufficient material has been removed from the top side of the tread, such as due to tread wear. In the embodiment shown, the width of the top groove is generally equal to the width of a groove arranged in the pre-existing tread of the tire carcass and over which the top groove is arranged or aligned.

FIG. 3 is a partial front sectional view of the tire of FIG. 2, whereby a portion of the tread has been removed from the top side, such as by wear, to expose opposing voids forming the transverse bounds of each removable tread section, the removable tread sections having been removed subsequent removal of such tread material to create a new void within the tire and additionally expose a groove arranged in the pre-existing tread layer of the tire carcass.

FIG. 4 is a partial front sectional view of a new tread layer applied to the tire of FIG. 1, the new tread layer comprising an alternative to the new tread layer of FIG. 2 whereby the removable tread section includes a top groove and has a width that is generally equal to a width of the bottom groove over top which the removable section is arranged or aligned according to a particular embodiment of the invention.

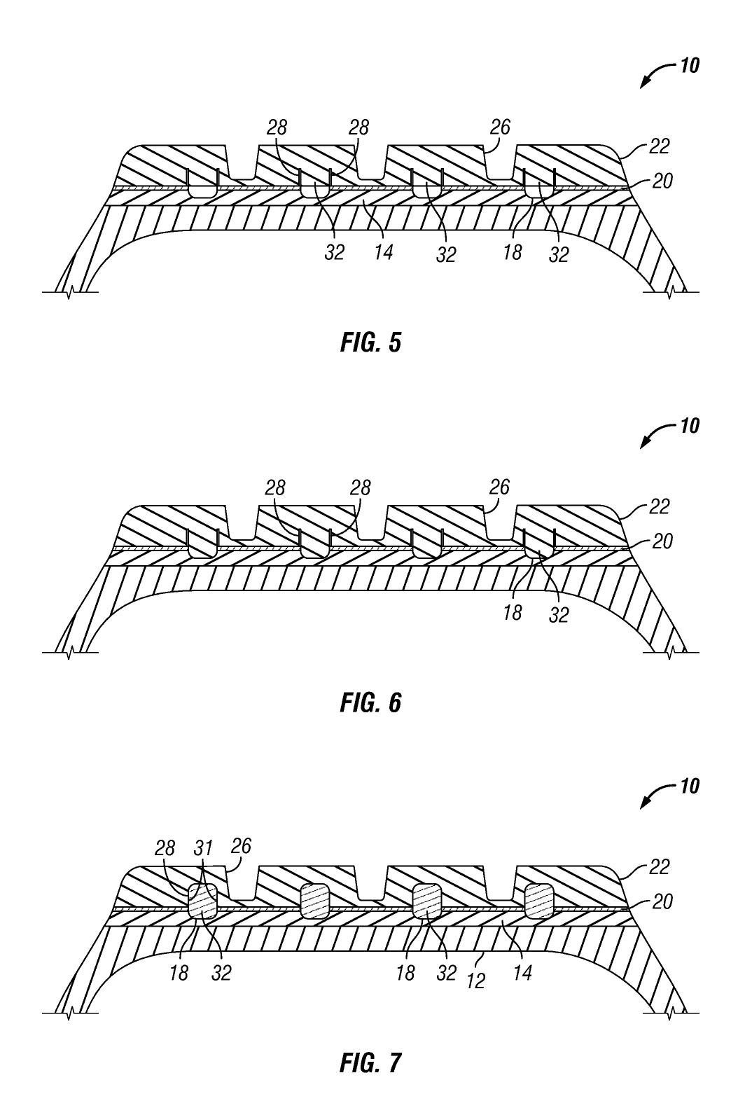

FIG. 5 is a partial front view of an alternative new tread layer attached to a tire, the new tread layer having removable tread sections arranged along a bottom side of the tread whereby any top grooves arranged along the top side are not arranged within any removable tread section according to a particular embodiment of the invention.

FIG. 6 is a partial front view of an alternative new tread layer attached to a tire, the new tread layer having removable sections extending below the bottom side surface to form protrusions extending into grooves arranged within the pre-existing tread layer of the tire carcass according to a particular embodiment of the invention.

FIG. 7 is a partial front view of a new tread layer attached to a tire, the tire including removable sections comprising frangible material arranged between the new tread layer and the tire carcass according to a particular embodiment of the invention, the removable sections being arranged within a bottom groove of the tread and a groove within the pre-existing tread layer of the tire carcass.

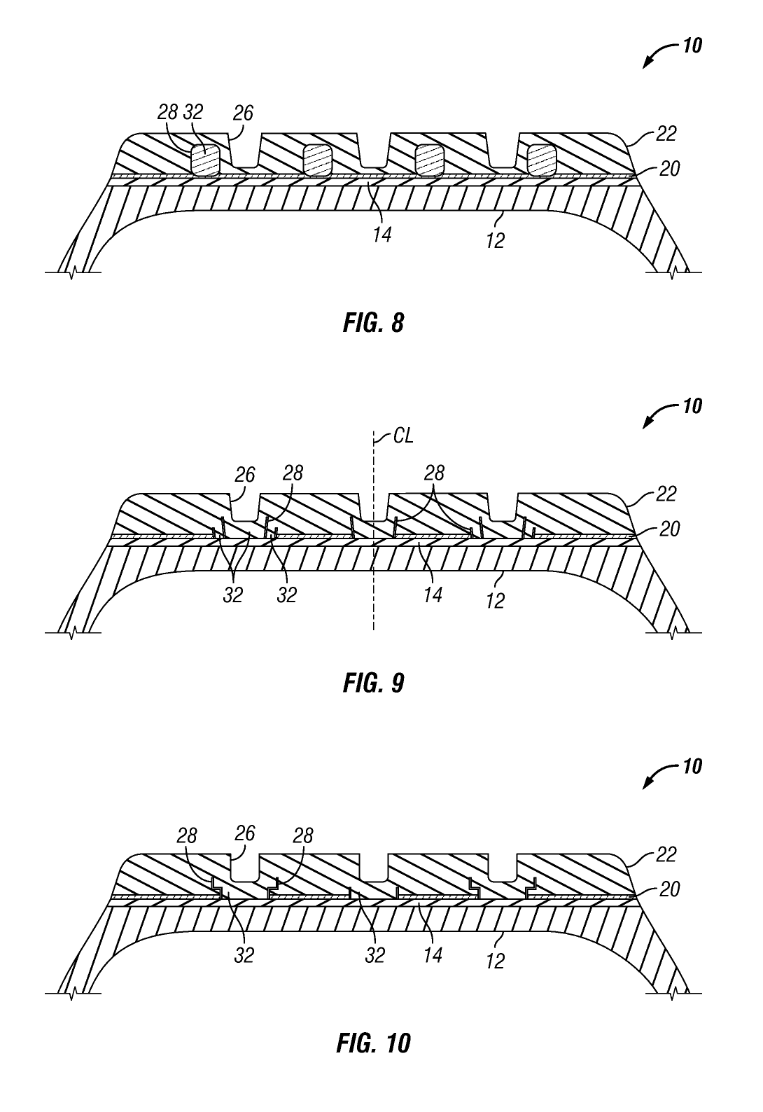

FIG. 8 is a partial front view of a new tread layer attached to a tire, the tire including removable sections comprising frangible material arranged between the new tread layer and the tire carcass according to a particular embodiment of the invention, the removable sections being inserted into a bonding layer arranged atop the tire carcass.

FIG. 9 is a partial front view of an alternative new tread layer attached to a tire, the new tread layer having removable tread sections arranged at different depths of the tread thickness and at different locations along a bottom side of the tread according to a particular embodiment of the invention.

FIG. 10 is a partial front view of an alternative new tread layer attached to a tire, the new tread layer having removable tread sections arranged along a bottom side of the tread whereby two of the removable tread sections form multiple wear layers as the transverse cross-sectional shape of the removable tread section forms two different width grooves in accordance with a particular embodiment of the invention.

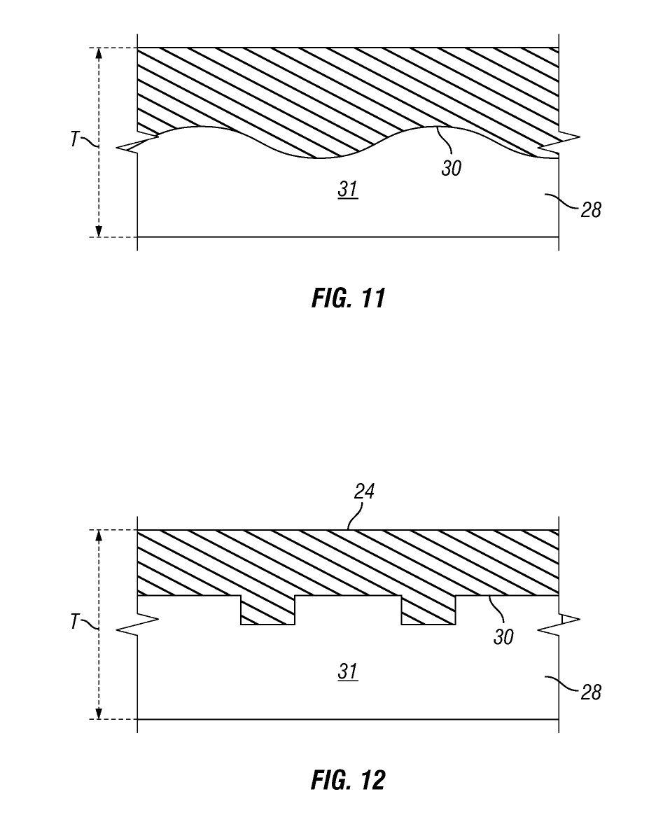

FIG. 11 is a sectional view of a discontinuity taken along section 11-11 of FIG. 2, the discontinuity having a terminal end that undulates, whereby when the tread is worn to expose the terminal end of the discontinuity, the terminal end will be selectively exposed to provide a removable tread section that is partially attached to the tread and which may be selectively removed before the discontinuity is fully exposed and the removable tread section thereby uncontrollably released.

FIG. 12 is a sectional view of an alternative embodiment of the discontinuity shown in FIG. 10, the discontinuity having a terminal end that undulates longitudinally along a stepped path.

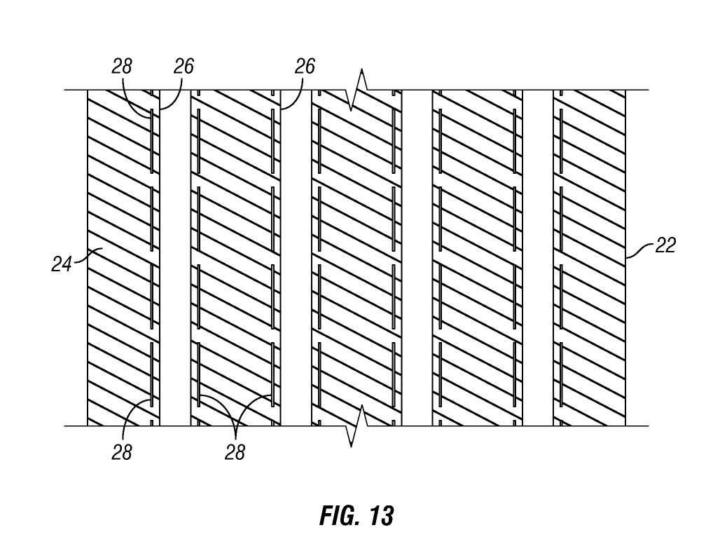

FIG. 13 is a top view of the tread of FIG. 2 taken along section 13-13 showing the terminal end of the removable tread section partially exposed along an outer worn side of the tread.

### DETAILED DESCRIPTION OF PARTICULAR EMBODIMENTS

Particular embodiments of the present invention provide tire treads for use in manufacturing retreaded tires. Tire retreading generally comprises placing a new tread on a pre-existing tire carcass. The tire carcass may be prepared to receive the new tread by any known means, such as by buffing, grinding, abrading, or cutting the prior tread from the carcass. Such means is generally referred to herein as a material removal operation. With reference to FIG. 1, for example, a worn tire carcass 12 is shown. The tire carcass includes a pre-existing tread layer 14 having grooves 18 extending into a thickness T₁₄ of the layer from a top or outer side 16. Prior to application of a new tread layer, a portion 14ₓ of the worn tread may be removed by a material removal operation, such as by use of an abrading or buffing tool or machine. Material may be removed to any desired depth D₁₄ₓ to prepare and adapt the pre-existing tread layer 14 for receiving a new tread layer of any particular shape, profile, and thickness. The removal of material may result in an outer side 16′ adapted to receive the new tread layer and any bonding material that may be arranged there between. The outer side 16′ may be arranged a constant distance from the bottom of each groove 18, or may be arranged a variable distance along the tread—laterally and/or longitudinally along the tread. With reference to the example shown in FIG. 1, outer side 16′ is arranged a constant distance from the bottom of each groove 18, and the thickness of the prepared pre-existing tread is generally a constant thickness with reference to outer side 16′.

Whether or not material is removed from the tire carcass pre-existing tread layer, a new tread is ultimately arranged atop the tire carcass to form a retreaded tire. Prior to applying the tread to the tire carcass, however, bonding material may be arranged between the new tread and the tire carcass to promote adhesion there between. Treads may be molded, and fully or partially cured prior to its application upon a tire carcass. In other variations, such treads may remain uncured when applied to a tire carcass. With reference to FIG. 2, an exemplary tread 22 is arranged atop a tire carcass 12, with bonding material arranged there between. The bonding material may comprise any known material suitable for its intended purpose of bonding the new tread to the tire carcass. For example, the joining material may comprise an adhesive or material curable by way of vulcanization, such as natural or synthetic rubber or any other elastomeric and/or polymeric material, which is commonly referred to as liaison rubber or cushion gum. In lieu of using bonding material, an uncured new tread may be sufficiently capable of bonding to the tire carcass without use of separate bonding material.

Tire treads commonly include a tread pattern arranged along an outer side or face (i.e., a top side or face) of the tread for engaging a ground surface during tire operation. The tread pattern comprises voids arranged along the top side, such as sipes and/or grooves, for example. Voids arranged along the top side are referred to herein as outer or top voids. Such treads may further include submerged or recessed voids arranged along an inner or bottom side of the tread, where such voids become exposed when sufficient tread material is removed from the outer side as the tread wears during tire operation. These recessed voids are referred to herein as inner or bottom voids. The voids, whether top of bottom voids, may comprise sipes or grooves, each of which may extend in any direction along the tread. For example, sipes or grooves may extend lengthwise in a longitudinal direction of the tread to form a longitudinal sipe or groove or in a lateral direction of the tread to form a lateral sipe or groove.

With reference to FIG. 2, for example, a new tread 22 is shown bonded to a tire carcass 12 to form a retreaded tire 10. New tread 12 is also referred to herein as a “new tread layer.” The tread 22 includes a top side or face 24 and a bottom side or face 25. Tread 22 further includes recessed removable tread portions 32 (which may also be referred to as “sections” or “elements”) extending into the tread thickness T from the bottom side 25 to a location recessed below the top side 24. Recessed removable tread portions comprise recessed features that become exposed when a depth of tread is removed from the tread top side, such as due to wear. And once the recessed removable tread portions become exposed to the tread top side, each becomes removable from the outer side. This is beneficial as it provides additional surface and/or volumetric void is desired as the tread wears. And by providing the removable tread portion in lieu of simply providing a recessed void, the structure of the removable tread portion provides a tread that is more rigid than a tread having recessed voids. Further, by using removable tread portions, the voids arranged along the pre-existing tread layer may be utilized, as opposed to being removed form the pre-existing tread layer by removing sufficient pre-existing tread material. Accordingly, more of the pre-existing tread layer is able to be used and not wasted according to common retreading practices.

The recessed removable tread portion may be selectively removed before it is fully exposed and automatically released or discharged due to centrifugal forces as the tire is rotating. It is desirous to selectively remove the removable tread portion prior to automatic release to avoid undesired consequences that may arise when the removal tread portion is discharged during tire and vehicle operation. To facilitate selective removal of the removable tread portion, with reference to the embodiment of FIG. 11, a discontinuity 28 has a terminal end 30 that undulates depthwise within the thickness T of the tread such that when the tread is worn to expose the terminal end of the discontinuity, the terminal end will be selectively or partially exposed along an outer side of the tread to provide a removable tread section that is partially attached to the tread and which may be selectively removed before the discontinuity is fully exposed and the removable tread section thereby uncontrollably released. The terminal end 30 of the discontinuity travels along a non-linear undulating path and in particular a curvilinear undulating path. Undulating connotes that the path alternates up and down depthwise within the tread thickness along any desired non-linear path. Depthwise connotes extending a depth into or within a tread thickness between top and bottom sides of the tread thickness. Any non-linear path may be employed. By further example, with reference to FIG. 12, a terminal end 30 of a discontinuity 28 alternates longitudinally along a stepped path. A selectively or partially exposed discontinuity 28 and removable tread portion 32 is shown by example in FIG. 13. Any arrangement of discontinuities and removable tread portions may be employed. Once partially exposed, a user may remove the removable tread portion 32 by any manual or automatic removal means, such as by using pliers. A lacerating member, such as a knife, may be employed to facilitate removal by completely separating the removable tread portion form the tread by cutting tread 33 arranged between exposed portions of a discontinuity 28.

Recessed removable tread sections may comprise any form or shape to form a desired void within a tread. Recessed removable tread sections may extend lengthwise in a longitudinal direction of a tread or laterally across a width of the tread. The recessed void may vary in depth as it extends lengthwise and/or transversely across its width. Still further, the recessed removable tread sections may comprise any cross-sectional shape extending transversely across its width and any cross-sectional shape extending longitudinally along its length. Ultimately, the recessed removable tread section may be shaped to form any desired void within the tread thickness, such as any shaped longitudinal or lateral groove or any other desired void, which includes a cylindrical void or any prism-shaped void, such as a cuboid for example. Recessed removable tread section may be formed as a portion of the tread or comprise an insert placed into the tread prior to or during the process of assembling a retreaded tire.

For example, with reference to the new tread layer of FIG. 2, a recessed removable tread portion 32 is formed with the new tread, whereby a pair of discontinuities 28 extend vertically into the tread thickness T from the bottom side 25. The pair of discontinuities form opposing interior tread surfaces between which the removable tread portion is arranged. The discontinuities in this figure may be formed by either sipes or slits molded into the bottom side of the tread, or by performing a lacerating operation after the tread has been molded to form pairs of lacerations in desired locations along the bottom side of the tread. Any desired means for lacerating may be employed, which may include the use of a knife or blade to lacerate the tread. Further, the discontinuities formed may extend any desired length. For example, each may extend lengthwise the full length of a tread, such as when used to form a longitudinal groove, or may extend in shorter lengths, such as when forming a removable tread section that does not extend a full length or width of the tread. For example, a longitudinal or lateral groove may be formed that does not extend the full tread length or width such as when extending between ribs or tread elements.

The discontinuities shown in FIG. 2, extend upward into the tread and terminate a depth Dₒ below the top side 24 of the new tread. Accordingly, the thickness of the tread associated with depth Dₒ is a first or preceding wear layer, while the thickness of the tread associated with the removable tread section 32 comprises as least a second or subsequent wear layer. Removal of a recessed removable wear section 32 forms at least a second or subsequent wear layer below thickness Dₒ because additional removable tread sections may be arranged below any recessed tread section within the thickness of the tread, such as is shown by example in FIG. 9, and/or because a recessed removable tread section may be shaped to provide different wear layers upon its removal, such as is exemplarily shown in FIG. 10. In FIG. 9, a first removable tread section is first exposed as the tire tread wears to form a first groove. As the tread continues to wear, two additional removable wear sections 32 arranged adjacent to the first removable wear section are exposed and ultimately removed from the tread to form a wider groove.

Once sufficient material has been removed from the outer tread side to a sufficient depth to fully expose the recessed tread section, the section may be removed as discussed above to form a volumetric void within the tread. This is shown by example in FIG. 3, whereby the tread of FIG. 2 has been worn to a depth Dₒ, such that the removable tread section is no longer constrained to the tread or tire and is removed to form a volumetric void 34, such as a longitudinal or lateral groove for example. To facilitate removal of the removable tread section, release material or agent 36 is placed between the removable tread section along the tread bottom side and the bonding layer or the tire carcass to prevent substantial bonding of the removable tread section to the tread carcass (such as through the bonding layer) during bonding operations after assembly of the retreaded tire. The release material is shown arranged within the tire in FIG. 2. It is understood, however, that the removable tread section may be releasable without use of any release material.

With reference to FIGS. 2 and 4, top voids 26 may be arranged to extend into the recessed removable tread section 32, such that, when, as shown, the top void is a groove, the recessed removable tread section provides a wider groove upon removal of the removable tread section with sufficient tread wear. It is understood, however, that the recessed removable tread section 32 may be narrower in width W₃₂ than the width W₂₆ of the top void 26, such as when the removable tread section is arranged between the top void and the bottom side of the tread—and the exposed void of the pre-existing tread layer. It is also understood that the width W₃₂ of a recessed removable tread section 32 may be approximately equal to the width W₁₈ of a groove or other void 18 arranged in the pre-existing tread layer 14 of the tire carcass 12. This is exemplarily shown in FIG. 4. The width W₃₂ of each removable tread section 32 may vary as desired. Accordingly, discontinuities 28 and surfaces 31 may extend radially depthwise through the tread thickness T along any desired path. For example, with reference to FIG. 9, each discontinuity 28 extends radially depthwise within the tread thickness T along path angled or biased relative tread centerline CL, whereby each discontinuity is arranged a variable distance from centerline CL as each extends through a depth of the tread thickness. In other words, each discontinuity 28 is not parallel with a plane extending along the tread centerline CL. The depthwise path of each discontinuity in FIG. 9 forms a removable tread portion 32 that narrows in width as it extends deeper into the tread from the tread outer side. In other arrangements, however, the discontinuities may be oppositely arranged such that the removable tread portion increases in width as it extends deeper into the tread. It is understood that each discontinuity may extend depthwise along any linear or non-linear in a cross-sectional plane. A non-linear path may be curvilinear for example, or may comprise a series of linear paths, such as is shown in one example in FIG. 10. A path extending parallel to a tread centerline CL is shown by example in FIGS. 2, 4-6.

As shown in FIGS. 2-4, recessed tread sections 32 may be arranged to align a top void 26 with a void 18 arranged in the tire carcass, such as to provide a top void of greater depth when it extends an additional depth into the tire carcass void 18 upon removal of the removable tread section. It is understood, however, that the top void 26 may not be aligned with any void in the tire carcass, such as is shown by example in FIGS. 5 and 6. This may be useful when trying to alter the arrangement of void along the tread between different wear layers. For example, in FIGS. 5 and 6 the tread 22 evolves from having three longitudinal grooves 26 in a first wear layer to having four longitudinal grooves in a subsequent wear layer upon the removal of recessed removable tread sections 32.

In FIGS. 2-5, 9, and 10, the recessed removable tread sections 32 have a bottom that is generally flush with the tread bottom side 25. It is understood, however, that such sections 30 may be recessed or protrude from the tread bottom side 25. For example, with reference to FIGS. 6-8, removable tread sections 32 extend or protrude from bottom side 25. This may be useful, such as when attempting to generally fill a similarly shaped void in the tire carcass and/or when attempting to used the protruding section 32 to align the tread atop the tire carcass.

A further example of removable tread sections 32 is shown with reference to FIGS. 7-8, whereby a recessed removable tread portion 32 comprises an insert formed separately from new tread 22. The insert 32 is arranged within a discontinuity 32 comprising a cavity within the tread bottom side. The cavity has opposing interior tire surfaces 31 between which the insert 32 is arranged. The insert and cavity may be similarly shaped such the insert generally fills the cavity and/or to allow that cavity to sufficiently constrain the insert within the cavity during assembly and tire operation. As discussed above, the insert may extend or protrude from the bottom side, even though similarly shaped to the cavity, or may be recessed as discussed more generally above. The insert may be formed of the same or similar material as compared to the tread, or may be formed of a frangible material that may fracture or break apart upon exposure to the top side. The fracturing or breaking apart of the insert may further promote and facilitate removal of the insert upon its exposure to the top side. In FIG. 7, the insert 32 is aligned with a void 18 in the tire carcass, and into which it is placed. In FIG. 8, the insert is forced into the bonding layer 20 during assembly of the retreaded tire, such that special application of the bonding layer and formation of like voids within the bonding layer is avoided.

Application of any tread contemplated herein atop a tire carcass may be performed according to various methods. In particular embodiments, a method of forming a retreaded tire having a tread comprising multiple wear layers comprises the steps of providing a tire carcass and providing any tread contemplated herein, where a multiple wear layer tread may comprise any combination of features discussed above. For example, the tread may comprise a thickness bounded depthwise by a ground-engaging top side and a bottom side, the thickness extending laterally between opposing side edges and longitudinally in a lengthwise direction of the tread, and a removable tread portion recessed from the top side to form a subsequent wear layer, the removable tread portion extending into the tread thickness from the bottom side and terminating a distance below the top side, the removable portion having a width arranged between opposing interior surfaces of the tread recessed below the top side. In particular steps, the tread may be arranged atop a tire carcass by arranging the removable tread portion of the bottom side over top an exposed void arranged along the outer side of a pre-existing tread layer of the tire carcass. For example, the exposed void is a groove, such as a longitudinal or a lateral groove. In particular embodiments the removable tread portion includes a protrusion extending outwardly from a bottom side of the tread, whereby the protrusion is arranged within the groove of the pre-existing tread layer.

Further steps may include bonding the tread to the tire carcass. This may be performed by any means for curing the new tread to the tire carcass that is known to one of ordinary skill in the art. This includes placing at least a portion of the assembled retread tire within a curing membrane, all of which is then placed within an autoclave or other curing device to cure the tread to the tire carcass.

Such methods may further include the step of placing bonding material between the tread and the tire carcass to facilitate bonding of the tread to the tire carcass, whereby the bonding material is placed such that the removable tread portion remains unbonded or unattached (i.e., free from attachment) to the tire carcass after the step of bonding has been performed. Further steps may include placing release material between the removable tread portion and the tire carcass prevent substantial bonding of the removable tread portion to the tire carcass in the step of bonding. Any release material known to one of ordinary skill in the art may be used.

Further steps may include removing a thickness of the tread from the outer side to expose the removable tread portion to thereby facilitate removal of the removable tread portion from the tread. For example, such removal may be comprise tread wear achieved during tire operation. Tread removal may also be achieved by performing any abrading or cutting operation, manually or automatically. Exposure of the removable tread portion may comprise, for example, exposing a void formed by one of first and second discontinuities arranged on opposing sides of a width of the removable tread portion. Such void extends longitudinally in a lengthwise direction of the removable tread portion, where the void may be continuous or discontinuous. By further example, exposure of the removable tread portion may comprise exposing a cavity within which an insert formed of frangible material is arranged. Upon exposure, the frangible insert may be broken or particularized such that portions of the insert are released from the tread through the exposed cavity.

Further steps of such methods may include removing the removable tread portion from a top side of the tread to expose a void arranged within the tread. Removal may also be performed by any means desired. For example, removal may be performed manually, which includes use of any hand tool such as a hook or pliers, or by any automatic operation. The void exposed may comprise any void. For example, the void exposed by removal of the removable tread portion may comprise a lateral or longitudinal groove.

While this invention has been described with reference to particular embodiments thereof, it shall be understood that such description is by way of illustration and not by way of limitation. Accordingly, the scope and content of the invention are to be defined only by the terms of the appended claims.

1. A multi-wear layer tire tread comprising:
a thickness bounded depth wise by a ground-engaging top side and a bottom side, the thickness extending laterally between opposing side edges and longitudinally in a lengthwise direction of the tread; and,
a removable tread portion recessed from the top side to form a subsequent wear layer, the removable tread portion extending into the tread thickness from the bottom side and terminating a distance below the top side, the removable tread portion having a width arranged between opposing interior surfaces of the tread recessed below the top side.

2. The tire tread of claim 1, the removable tread portion comprising a portion of the tread extending downward from the top side of the tread to a location between the opposing interior surfaces.

3. The tire tread of claim 2, where the removable tread portion is monolithic with the tread.

4. The tire tread of claim 3, where the opposing side surfaces comprise a first side surface and a second side surface, the first side surface being associated with a first discontinuity recessed below the top side and extending into the tread thickness from the bottom side and the second side surface being associated with a second discontinuity recessed below the top side and extending into the tread thickness from the bottom side.

5. The tire tread of claim 4, wherein the discontinuity is a sipe or laceration.

6. The tire tread of claim 4, where at least one of the first and second discontinuities have a terminal end arranged a variable distance below the top side.

7. The tire tread of claim 1, the removable portion comprising an insert arranged within a cavity recessed below the top side and extending into the tread thickness from the bottom side, the cavity having a width bounded by the opposing interior tread surfaces recessed below the top side.

8. The tire tread of claim 7, where the insert is formed of frangible material.

9. The tire tread of claim 1, where a top groove extending into the tread thickness from the top side is arranged above the removable tread portion.

10. The tire tread of claim 9, where the top groove extends downward into the removable tread portion from the top side.

11. The tire tread of claim 1, where the removable tread portion protrudes from the bottom side.

12. The tire tread of claim 1, where the tread is attached to a tire carcass to form a retreaded tire, the removable tread portion being arranged over top a groove formed in a pre-existing tread layer in the tire carcass.

13. The tire tread of claim 1, where bonding material is arranged between the tread and the tire carcass except for an area between the removable tread portion and the tire carcass is generally free of bonding material.

14. The tire tread of claim 13, where release material is arranged between the removable tread portion and the tire carcass.

15. A retreaded tire comprising:
a multi-wear layer tire tread comprising:
a thickness bounded depth wise by a ground-engaging top side and a bottom side, the thickness extending laterally between opposing side edges and longitudinally in a lengthwise direction of the tread; and,
a removable tread portion recessed from the top side to form a subsequent wear layer, the removable tread portion extending into the tread thickness from the bottom side and terminating a distance below the top side, the removable tread portion having a width arranged between opposing interior surfaces of the tread recessed below the top side;
a tire carcass upon which the tire tread is annularly arranged.

16. The retreaded tire of claim 15, wherein the removable tread portion is arranged overtop a void arranged along a pre-existing tread layer of the tire carcass, the pre-existing tread layer arranged annularly along an outer side of the tire.

17. The retreaded tire of claim 16, wherein the void is an exposed groove.

18. A method of forming a retreaded tire having a tread comprising multiple wear layers, the method comprising the steps of:
providing a tire carcass;
providing a tread comprising:
a thickness bounded depth wise by a ground-engaging top side and a bottom side, the thickness extending laterally between opposing side edges and longitudinally in a lengthwise direction of the tread; and,
a removable tread portion recessed from the top side to form a subsequent wear layer, the removable tread portion extending into the tread thickness from the bottom side and terminating a distance below the top side, the removable tread portion having a width arranged between opposing interior surfaces of the tread recessed below the top side;
bonding the tread to the tire carcass.

19. The method of claim 18, the method further comprising the step of:
placing bonding material between the tread and the tire carcass to facilitate bonding of the tread to the tire carcass, whereby the bonding material is placed such that the removable tread portion remains unbonded to the tire carcass after the step of bonding has been performed.

20. The method of claim 19, the method further comprising the step of:
placing release material between the removable tread portion and the tire carcass prevent substantial bonding of the removable tread portion to the tire carcass in the step of bonding.

21. The method of claim 18, the method further comprising the step of:
arranging the tread atop the tire carcass such that the removable tread portion is aligned overtop a groove contained in an outer side of a pre-existing tread layer of the tire carcass.

22. The method of claim 18, the method further comprising the steps of:
removing a thickness of the tread from the outer side during a wearing operation to expose the removable tread portion; and,
removing the removable tread portion from a top side of the tread to expose a void arranged within the tread.
